(19) United States
(12) Patent Application Publication
(10) Pub. No.: US 2010/0023745 A1
(43) Pub. Date: Jan. 28, 2010

(54) MEMORANDUM-PRESENTING METHOD AND COMPUTER SYSTEM USING THE SAME

(75) Inventor: Ming-Jung Wu, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTeK COMPUTER INC., Taipei (TW)

(21) Appl. No.: 12/500,865

(22) Filed: Jul. 10, 2009

(30) Foreign Application Priority Data
Jul. 24, 2008 (TW) 097128049

(51) Int. Cl. G06F 9/00

(52) U.S. Cl. 713/2

(57) ABSTRACT

A memorandum-information presenting method and a computer system using the method are provided. The computer system allows the memorandum-information to be presented and/or edited during a booting procedure, for example, while executing BIOS codes, initializing various components, checking hardware, allocating resources, or assisting to load an operating system. Accordingly, a user may read or edit the information without waiting for the computer system to successfully enter an operating system.

### FIELD OF THE INVENTION

The present invention relates to a memorandum-presenting method, and more particularly to a memorandum-presenting method performed by a computer system for allowing a user to read and/or edit the memorandum information.

### BACKGROUND OF THE INVENTION

As modern technology progresses rapidly, the use of computer systems has prevailed among general consumers. The application range of computer systems is also expanding, from personal computers (PCs) in the past, to notebook computers (NBs) later on, toward media centers and slim-type NBs, and other areas in recent years.

The basic components of a main board of a typical PC or NB include a central processing unit (CPU), a chipset for controlling various devices, some peripheral circuits, memories, a display adapter, etc. As the application range of computer systems expands, the peripheral devices built upon computer systems become more and more diversified. For example, to set up a local area network or to link to the internet, a network adapter has to be installed onto a main board of a computer system; to write data into a compact disk (CD), a CD burner has to be equipped in a computer system; to print data, a printer is needed by a computer system; to held a video conference, a web camera is needed by a computer system, and so on.

Usually there are information specific to the CPU, chipset and peripheral devices built on the mother board of the computer system, for example, including a brand name, model No., CPU operating speed, size of memory, type of memory, e.g. synchronous dynamic random access memory (SDRAM), double-date-rate (DDR) SDRAM, or DDR2 SDRAM, image-data-processing speed of the display adapter, exclusive media access control (MAC) address of the network adapter, etc. The information is useful when upgrading the computer system to determine if the replaced peripheral devices are compatible, and/or when updating firmware of peripheral devices. Generally the information is acquired via an operating system built in the computer system. However, when a hard disk drive (HDD) of the computer system fails without any early portent, causing the operating system built in the computer system unable to be executed, then the relevant information of these devices cannot be acquired until the HDD is restored and the operating system is successfully activated.

### SUMMARY OF THE INVENTION

Therefore, an object of the present invention is to provide a memorandum-information presenting method, which can be acquired before a computer system enters an operating system.

According to an aspect of the present invention, a memorandum-information presenting method performed by a computer system includes step of: powering on the computer system and executing BIOS codes in a booting procedure; and presenting a memorandum-information in response to a trigger instruction given during the booting procedure.

In accordance with another aspect of the present invention, a memorandum-information presenting method performed by a computer system includes step of: powering on the computer system and executing BIOS codes in a booting procedure; and retrieving a memorandum-information from a storage unit in response to a user's trigger action, editing the memorandum-information in response to the user's input, and saving the edited memorandum-information back to the storage unit for next retrieval during the booting procedure.

In accordance with a further aspect of the present invention, a computer system with a memorandum-information presenting function includes: a BIOS storage unit, storing therein BIOS codes and memorandum-information; a host in communication with the BIOS storage unit, retrieving and executing the BIOS codes in a booting procedure; and an input device in communication with the host, and issuing a trigger instruction to have the host retrieve the memorandum-information from the BIOS storage unit for revealing or editing during the booting procedure.

By way of the above-mentioned approaches, a user may acquire and/or edit the memorandum-information during the booting procedure. Thus even when the computer system fails to enter the operating system, the information relating to the computer system or other desired information can still be retrieved from a predetermined storage unit.

### BRIEF DESCRIPTION OF THE DRAWINGS

The above contents of the present invention will become more readily apparent to those ordinarily skilled in the art after reviewing the following detailed description and accompanying drawings, in which:

FIG. 1A and FIG. 1B are functional block diagrams of a computer system with a memorandum-information presenting function according to an embodiment of the present invention;

FIG. 2A is a flowchart illustrating a first embodiment of a memorandum-information presenting method according the present invention;

FIG. 2B is a schematic diagram exemplifying a trigger action performed by a user to present the memorandum-information based on the method of FIG. 2A;

FIG. 3A is a flowchart illustrating a second embodiment of a memorandum-information presenting method according the present invention; and

FIG. 3B is a schematic diagram exemplifying a trigger action performed by a user to present the memorandum-information based on the method of FIG. 3A.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

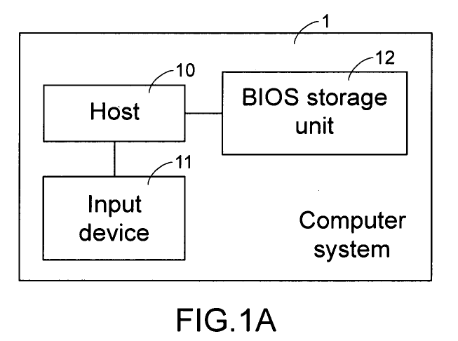

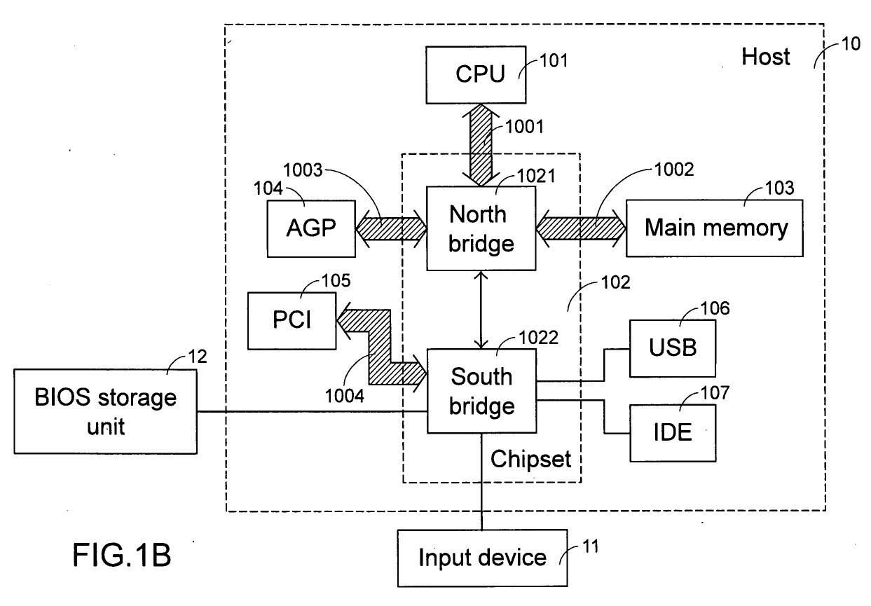

Please refer to FIG. 1A, which illustrates a computer system capable of exhibiting a memorandum-information presenting function according to the present invention. As shown, the computer system 1 comprises a host 10, an input device 11, and a BIOS storage unit 12, wherein the input device 11 is in communication with the host 10, and for example, can be a keyboard, a mouse, or any other suitable device capable of inputting information to the host. The BIOS storage unit 12 stores therein BIOS codes, and for example, can be implemented with a flash memory or electrically-erasable programmable read-only memory (EEPROM). Furthermore, as illustrated in FIG. 1B, the host 10 includes a CPU 101, which is a main part of the computer system 10, in communication with a chipset 1021 consisting of a north bridge chip 1021 and a south bridge chip 1022. The north bridge chip 1021 is in communication with the CPU 101 via a front side bus (FSB) 1001, in communication with a main memory 103 via a memory bus 1002, and in communication with an accelerated graphics port (AGP) via an AGP bus 1003. The south bridge chip 1022 is in communication with a peripheral component interconnect (PCI) 105 via a PCI bus 1004. There are further a universal serial bus (USB) interfere 106 and an integrated drive electronics (IDE) interface 107 in communication with the south bridge chip 1022 included in the host 10. From the drawing, it can be seen that the above-mentioned BIOS storage unit 12 is in communication with the south bridge chip 1022. After the host 10 is powered on, the booting procedure starts, and the BIOS codes stored in the BIOS storage unit 12 are executed. Afterwards, in response to an operation of a user on the input device 11, an instruction is issued to the host 10 to retrieve memorandum information from the BIOS storage unit 12 for reading or editing. The memorandum information, if edited, is saved back to the BIOS storage unit 12.

As mentioned above, the booting procedure, starting after the computer system 1 is powered on, includes initializing various components, verifying hardware, allocating resources, and assisting to load the operating system by way of executing the BIOS codes. The execution of the BIOS codes includes verifying if the data in a complementary metal-oxide-semiconductor (CMOS) of the south bridge chip 1022 is correct. If it is correct, then the data in the CMOS and other found hardware information will be compiled into a table, and written into the main memory 103. If an error is found, the data provided via CMOS will be replaced by the default value automatically. After the setup value preset in the CMOS by the user is verified, a series of operations for hardware test will be executed. Generally, the first image shown on the display after the host is powered on is associated with a memory-test stage, which is so called as power on self test (POST). In POST, the BIOS further checks if the CPU 101, main memory 103 and other relevant peripheral controllers are in ready conditions, and provides basic tests for main memory 103. After passing all the tests, the basic hardware information is revealed during the POST phase. Furthermore, a current computer system, after being powered on, executing the BIOS codes and starting the booting procedure, e.g. during the step of checking hardware (POST phase), generally allows a user to selectively input a variety of settings such as quick booting setting, booting disk setting, BIOS pin setting, etc. via a BIOS setup interfere which is entered by pressing a designated key, e.g. a “DEL” key, on a keyboard.

The memorandum-presenting method according to the present invention may also be executed during the POST phase. Alternatively, the memorandum-presenting method can also be executed during other steps of the booting procedure, for example, while initializing various components, allocating resources or assisting to load the operating system. The memorandum-information, if edited, is stored into in the BIOS storage unit 12 or a blank area of the CMOS in the south bridge chip 1022. Afterwards, the updated memorandum-information can be retrieved form the BIOS storage unit 12 or the CMOS in the south bridge chip 1022 as described above.

In brief, the present invention utilizes the BIOS-code revisable feature exhibited by a common computer system during the booting procedure to provide the computer system the functions of presenting and editing the memorandum-information. The memorandum-information can be easily edited by way of basic word processing. Accordingly, even when the computer system fails to start the operating system, the memorandum-information and/or other information of the computer system can still be acquired by retrieving the desired information from the BIOS storage unit. Hereinafter, examples are given to describe the present invention in more detail.

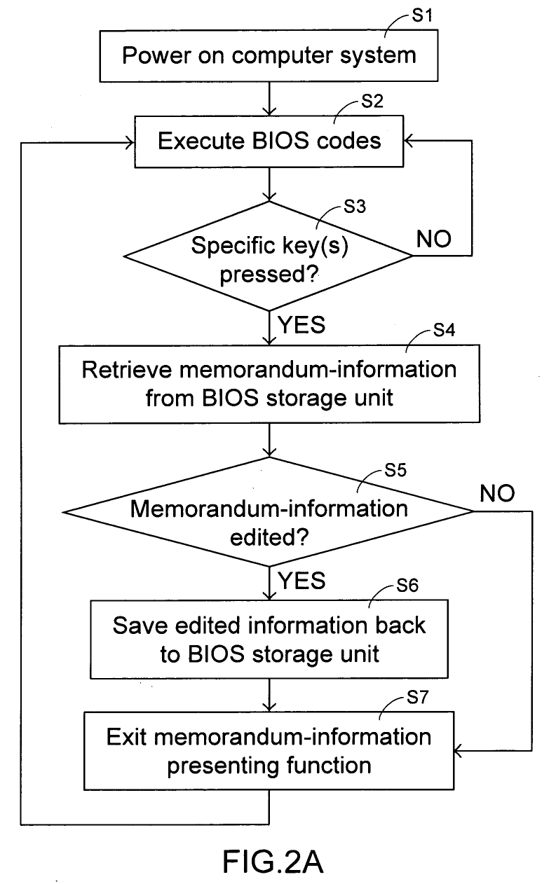

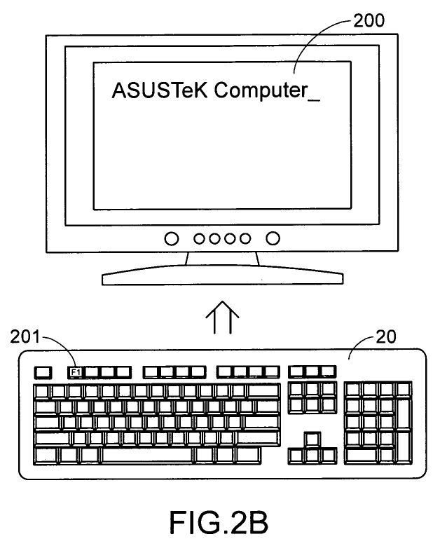

Please refer to FIG. 2A and FIG. 2B, which illustrate a first embodiment of a memorandum-information presenting method according to the present invention. In this embodiment, a keyboard is given as an example of an input device of a computer system for presenting/editing the memorandum-information. It can be seen from the flowchart shown in FIG. 2A, after the computer system is powered on (Step S1), BIOS codes are executed to execute a booting procedure (Step S2). During the booting procedure, if a specific one or a specific key combination among a plurality of keys on the keyboard for activating the memorandum-information presenting function is triggered, (Step S3), retrieve the memorandum-information from the BIOS storage unit (Step S4). Otherwise, go on the booting procedure (Step 2). If the memorandum-information is edited (Step S5), the edited information is saved back to the BIOS storage unit (Step S6). After the memorandum-information is processed, exit the memorandum-information presenting function (Step S7) and go on the booting procedure (Step 2). The subsequent booting procedure, for example, includes checking the CPU and other controllers, initializing peripheral devices, loading the operating system, etc.

It is to be noted that the step of activating the memorandum-information presenting function (Step S3) is executed by pressing the specific key or key combination before the operating system is loaded. For example, the specific key can be a functional key “F1” 201 on the keyboard 20, and the memorandum-information is shown on a display 200 in response to the pressing action, as shown in FIG. 2B.

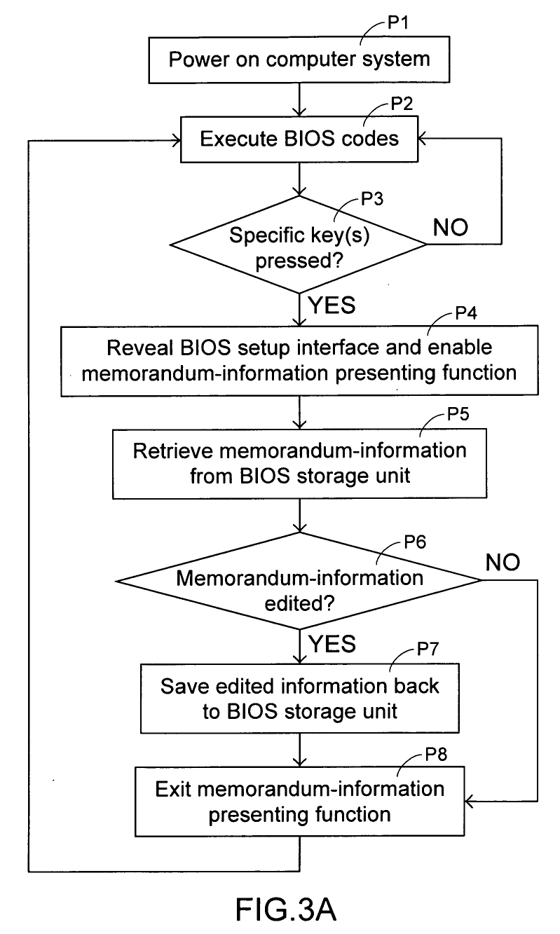

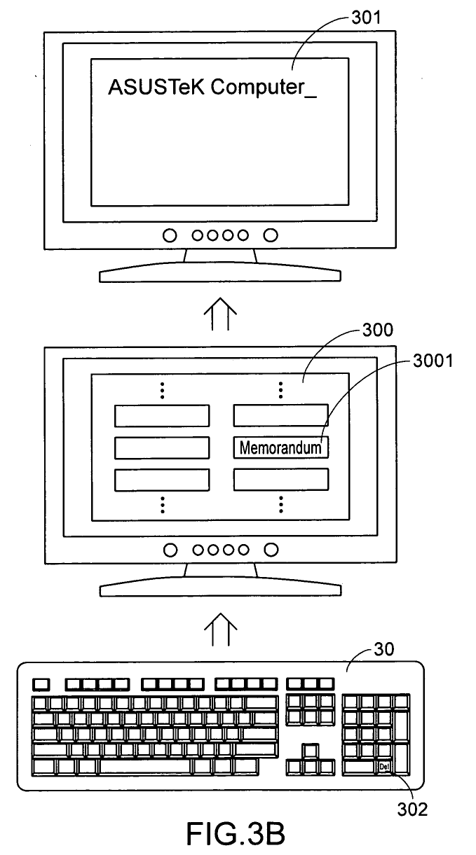

FIG. 3A and FIG. 3B illustrate a second embodiment of the memorandum-information presenting method according to the present invention. In this embodiment, a keyboard is also used as an example of an input device. After the computer system is powered on (Step P1), BIOS codes are executed to execute a booting procedure (Step P2). During the booting procedure, if a specific one or a specific key combination among a plurality of keys on the keyboard for activating BIOS settings is triggered (Step P3), reveal a BIOS setup interface where a memorandum-information presenting function is available for selection (Step P4). Otherwise, go on the booting procedure (Step P2). Once the memorandum-information presenting function is selected in Step P4, the memorandum-information is retrieved from the BIOS storage unit (Step P5). If the memorandum-information is edited (Step P6), the edited information is saved back to the BIOS storage unit (Step P7). After the memorandum-information is processed, exit the BIOS setup interface (Step P8) and go on the booting procedure (Step P2).

It is to be noted that the step of activating the BIOS settings (Step P3) is executed by pressing the specific key or key combination before the operating system is loaded. For example, the specific key can be a key “DEL” 302 on the keyboard 30, and a BIOS setup interface 300 including a selective item 3001 for presenting the memorandum-information is shown on a display 301 in response to the pressing action, as shown in FIG. 3B. By triggering the selective item 3001, the memorandum-information is shown on the display 301.

In view of the foregoing, it is understood that the present invention can be implemented by modifying BIOS commonly existent in computer systems. That is, the memorandum-information can be presented during the booting procedure. By providing a basic word processing function to the phase of executing BIOS, the memorandum-information can be further edited by way of word processing while the computer system is still executing BIOS.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A memorandum-information presenting method performed by a computer system, comprising steps of:
powering on the computer system, and executing BIOS codes in a booting procedure; and
presenting a memorandum-information in response to a trigger instruction given during the booting procedure.

2. The method according to claim 1, wherein the trigger instruction is issued by pressing a specific one or a specific key combination among a plurality of keys on a keyboard in communication with the computer system.

3. The method according to claim 1, wherein the trigger instruction is issued by pressing a specific one or a specific key combination among a plurality of keys on a keyboard to reveal a BIOS setup interface and selecting a memorandum-information presenting item in the BIOS setup interface.

4. The method according to claim 1, wherein the booting procedure, in addition to executing the BIOS codes, further includes initializing various components, checking hardware, allocating resources, and assisting to load an operating system.

5. The method according to claim 1, wherein the memorandum-information includes hardware-associated information of the computer system.

6. A memorandum-information presenting method performed by a computer system, comprising steps of:
powering on the computer system, and executing BIOS codes in a booting procedure; and
retrieving a memorandum-information from a storage unit in response to a user's trigger action, editing the memorandum-information in response to the user's input, and saving the edited memorandum-information back to the storage unit for next retrieval during the booting procedure.

7. The method according to claim 6, wherein the trigger action is to press a specific one or a specific key combination among a plurality of keys on a keyboard in communication with the computer system.

8. The method according to claim 6, wherein the trigger action is to press a specific one or a specific key combination among a plurality of keys on a keyboard in communication with the computer system to reveal a BIOS setup interface and to select a memorandum-information presenting item in the BIOS setup interface.

9. The method according to claim 6, wherein the booting procedure, in addition to executing the BIOS codes, further includes initializing various components, checking hardware, allocating resources, and assisting to load an operating system.

10. The method according to claim 6, wherein the memorandum-information includes hardware-associated information of the computer system.

11. A computer system with a memorandum-information presenting function, comprising;
a BIOS storage unit, storing therein BIOS codes and memorandum-information;
a host in communication with the BIOS storage unit, retrieving and executing the BIOS codes in a booting procedure; and
an input device in communication with the host, and issuing a trigger instruction to have the host retrieve the memorandum-information from the BIOS storage unit for revealing or editing during the booting procedure.

12. The computer system according to claim 11, wherein the BIOS storage unit is flash memory or electrically-erasable programmable read-only memory (EEPROM).

13. The computer system according to claim 11, wherein the input device is a keyboard in communication with the computer system.

14. The computer system according to claim 13, wherein the trigger instruction is issued by pressing a specific one or a specific key combination among a plurality of keys on the keyboard.

15. The method according to claim 13, wherein the trigger instruction is issued by pressing a specific one or a specific key combination among a plurality of keys on the keyboard to reveal a BIOS setup interface and selecting a memorandum-information presenting item in the BIOS setup interface.

16. The method according to claim 11, wherein the booting procedure, in addition to executing the BIOS codes, further includes initializing various components, checking hardware, allocating resources, and assisting to load an operating system.

17. The method according to claim 11, wherein the memorandum-information includes hardware-associated information of the computer system.
